(19) United States
(12) Patent Application Publication
(10) Pub. No.: US 2006/0053156 A1
(43) Pub. Date: Mar. 9, 2006

(54) Systems and methods for developing intelligence from information existing on a network

(76) Inventors: Howard Kaushansky, Nederland, CO (US); Ted V. Kremer, Boulder, CO (US); David B. Howlett, Longmont, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 11/219,975

(22) Filed: Sep. 6, 2005

Related U.S. Application Data
(60) Provisional application No. 60/607,230, filed on Sep. 3, 2004.

(51) Int. Cl. G06F 17/30

(52) U.S. Cl. 707/102

(57) ABSTRACT

Systems and methods for analysis and generating reports presenting analysis involving capturing unstructured data from online information services. Speaker attributes and semantic attributes associated with items of the captured data are determined. The captured data, speaker attributes, and semantic attributes are analyzed to generate processed information based on the captured data. A report is generated to present the processed information.

### RELATED APPLICATIONS

The present invention claims the benefit of U.S. Provisional application No. 60/607,230 filed on Sep. 3, 2004 which is incorporated herein by reference.

### BACKGROUND OF THE INVENTION

1. Field of the Invention

The present invention relates, in general, to collecting and analyzing information, statements and other data, and, more particularly, to software, systems and methods for collecting, analyzing and reporting intelligence data from unsolicited information existing on a network.

2. Relevant Background

Worldwide, companies spend billions each year on market research; however, due to lack of time and cooperation, traditional market research is growing increasingly difficult to conduct. Further, traditional market research fails to capture the speed with which change occurs in today's world. At the same time, a vast amount of highly reliable information including honest, unsolicited opinion data and information is continually posted on various networked information sources such as web sites, weblogs (a.k.a., “blogs”), chat services, message services, Usenet groups and the like. To date there have been no systems that are able to effectively turn this vast arena of unstructured data into meaningful market intelligence.

In commerce, public administration, and a variety of other fields collecting, analyzing and reporting opinion data remains a task of significant importance. Conventional approaches to access opinion information generally involve polling or surveying in person and by mail or telephone. A survey participant may participate in a focus group and/or be mailed a standard survey form to complete and return by mail or an agent of the provider may call a participant so that the survey questions may be answered over the telephone.

However, these methods of performing surveys are inaccurate and inefficient, often taking considerable time to collect and process the information. For example, a traditional in-person survey, focus group, or direct mail survey may take months before a provider reviews a final report. Many people find in-person and telephone surveys to be intrusive. Computer-administered surveys may improve speed and efficiency by automating some processes. However, computer-administered surveys often fail to assess a variety of implicit characteristics of the response and/or respondent that a human survey specialist could imply from the tone, content, and manner in which the response to a particular question is given. Moreover, computer administered surveys are subject to the same biases and errors introduced by other survey techniques that are based on prompting or soliciting responses.

Survey responses are inherently influenced by the form of the questions or manner of delivering questions while administering the survey. For example, the form of a question may explicitly or implicitly constrain the range of responses, or lead a respondent towards or away from a particular response. These biases are often unintentional and therefore difficult to compensate for when analyzing results. Hence, to obtain accurate results requires great expense of having polling specialists generate questions and using highly trained personnel or sophisticated software to administer each survey.

Even in a carefully constructed survey there are some questions that inherently perturb responses, such as questions about gender, age, ethnicity, geographic location/origin of the respondent, political affiliation and the like. Such questions may lead to skewed responses when the respondent is hesitant to reveal the information, and in worst cases may lead the respondent to give false responses. Also, such questions may lead to responses that cannot be fully utilized due to privacy policies and/or privacy laws that prohibit use and/or distribution of certain types of information.

It would be advantageous to automate the processes involved in collecting, analyzing and reporting opinion data to reduce the personnel requirements, to increase the accuracy, reduce the costs, improve the efficiencies, and overcome the shortcomings of current techniques identified above.

### SUMMARY OF THE INVENTION

Briefly stated, the present invention involves a method for generating intelligence and intelligence reports by capturing unstructured data from online information services. Speaker attributes and semantic attributes associated with items of the captured data are determined. The captured data, speaker attributes, and semantic attributes are analyzed to generate processed information based on the captured data. A report is generated to present the processed information.

Contemplated implementation of the present invention include market research reports that enable companies to better understand the opinions and perspectives of an online community, gain a richer understanding of their position in the market relative to the competition, as well as to identify new trends, directions impacting their products and the directions their products take. The present invention may also be used in a variety of other applications where a person or organization desires to better understand the opinions and perspectives of an online community.

### BRIEF DESCRIPTION OF THE DRAWINGS

FIG. 1 shows a networked computer environment in which the present invention is implemented;

FIG. 2 is a simplified flow diagram of steps in accordance with an exemplary implementation of the present invention;

FIG. 3 conceptually illustrates a semantic map useful in understanding classification processes in accordance with the present invention;

FIG. 4 illustrates an analysis process in accordance with the present invention; and

FIG. 5 through FIG. 11, together with the exemplary report attached as an Appendix, show examples of data presented in a report generated in accordance with the present invention.

### DETAILED DESCRIPTION OF THE PREFERRED EMBODIMENTS

The present invention involves systems and method for generating market research reports from unstructured data. The present invention also involves services that collect unstructured data, such as unsolicited opinion data and/or other information, from an online community. The online community is represented by data made available by a variety of services such as weblogs, chat rooms, message boards, Usenet postings, web sites, and the like. Representing over 30 million voices, the online community is an untapped, honest and deep well of opinion information about companies, products, political opinions, people and positions. The online community represents one of the rawest, most emotive “grassroots” forums for individuals to assert their likes, dislikes, preferences and opinions over the Internet. People using Weblogs, or “bloggers,” represent a highly progressive and highly opinionated segment of our population, while “chatters” represent a broader slice of society, spanning a wide range of demographics.

The present invention analyzes and transforms the gathered data into useful marketing intelligence about, for example, a company, its products and its competition. The particular implementations described herein access weblogs to obtain data that resides on a network, which may include opinion data, commentary and the like. The invention is readily adapted to use other sources and types of online data. Exemplary sources of useful data include weblogs, web sites, chat rooms, message boards, Usenet groups, electronic mail, instant messaging (IM), podcasts, as well as video streams, audio streams and the like that have been transformed to a textual representation, among other sources.

The present invention involves a market intelligence service that crawls and analyzes the information from various sources at which the online community is represented in a network. In particular embodiments the present invention uses natural language processing (NLP) and machine learing algorithms to provide a synopsis of what is being said as well as the explicit and/or implied attributes of the speaker to provide a new and untapped source of marketing research and competitive intelligence. As used herein, the word “speaker” is intended to refer to the person who authors or contributes information to the online community. Speaker attributes include gender, age, education, political affiliation, income, ethnicity, sexual preference, education, household size, family size, community size, home ownership, and other attributes that describe something about the speaker/author of information obtained from online sources. Some speaker attributes may by explicitly provided by the speaker. While explicitly provided information is useful, the present invention expands on this by providing techniques for implying speaker attributes using techniques such as linguistic analysis.

In a particular implementation the present invention is implemented as a centralized market intelligence service in one or more network-connected servers. The service provides data collection processes that function to gather data from the online community, analysis processes that function to provide linguistic, statistical, or other analysis functions, and reporting processes that function to present organized and analyzed information to users. Additionally, the market intelligence service includes user interface processes that allow users to access the system and specify criteria that define desired market intelligence reports.

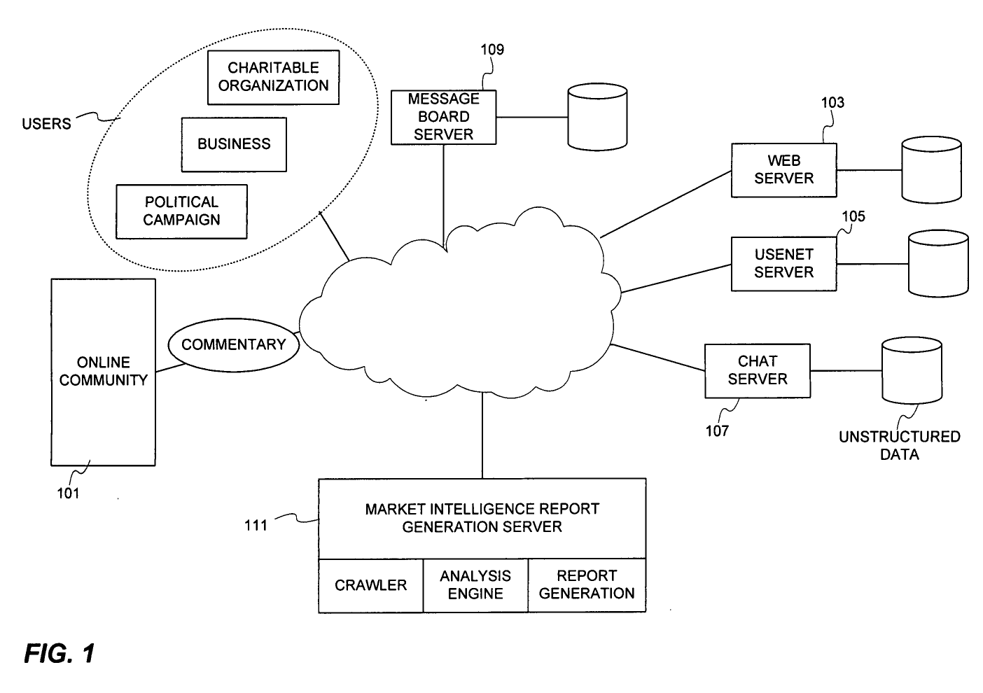

FIG. 1 shows a networked computer environment in which the present invention is implemented. An online community 101 comprises primarily individuals who form the online community by contributing information in the form of commentary to various online information services such as weblogs implemented by web server 103, newsgroup posting via Usenet Server 105, chat postings via server 107, message board postings via message board 109, and the like. It should be understood that the online community 101 can comprise any number of individuals, and the various information services are implemented in hundreds or thousands of servers distributed throughout the Internet.

The present invention is implemented, for example, by market intelligence report generation server 111 that is coupled to be accessed by users 113 via a network. Users 113 can submit report requests to market intelligence report generation server 111 and receive generated reports from market intelligence report generation server 111 using, for example, internet protocol (IP) messages (e.g., HTTP, SMTP, and the like). Users 113 may represent the ultimate consumer of an intelligence report or may represent a specialist who generates intelligence reports for an ultimate consumer. Market intelligence report generation server 111 includes processes to implement a network interface, implement a user interface for communicating with users 113, crawler processes for collecting unstructured data from the various information sources, analysis processes for analyzing the unstructured data, and report generation processes for formatting analyzed data in to a form suitable for presentation to users 113.

Data Collection

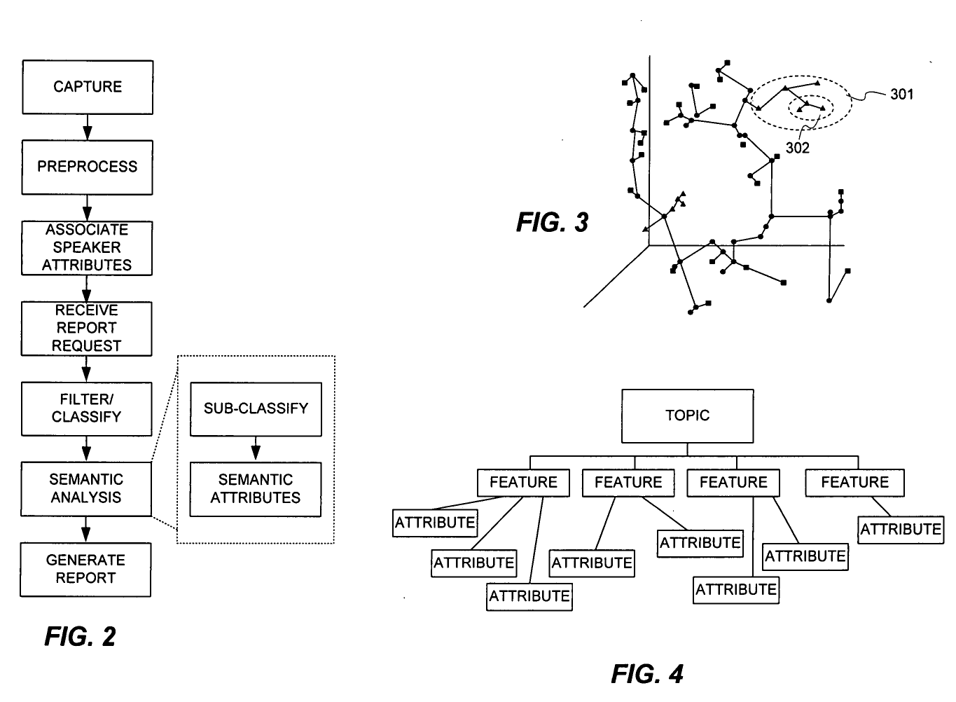

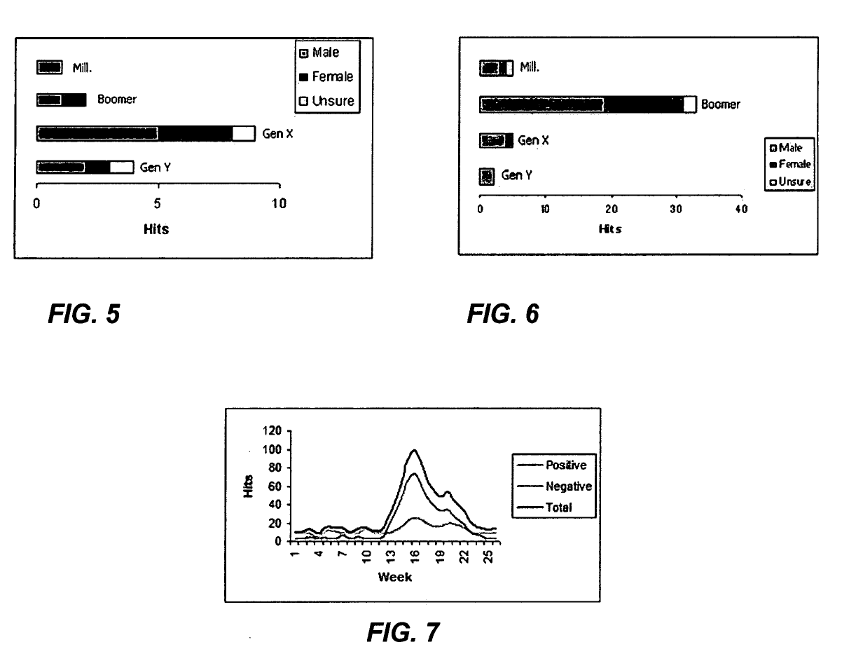

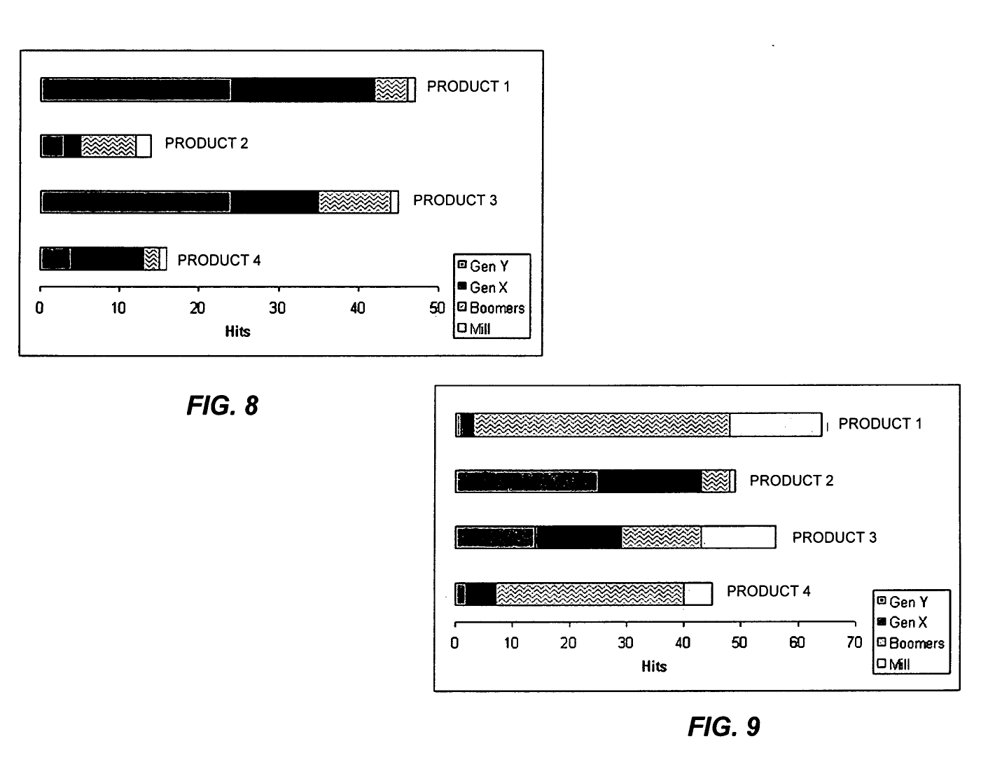

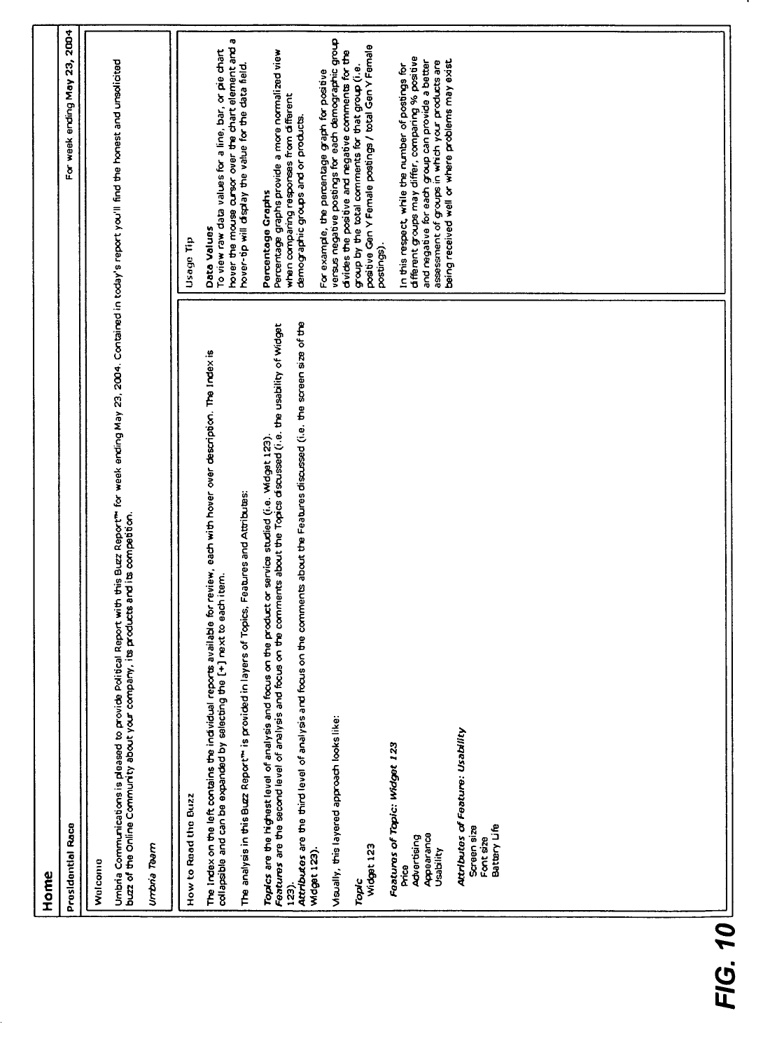

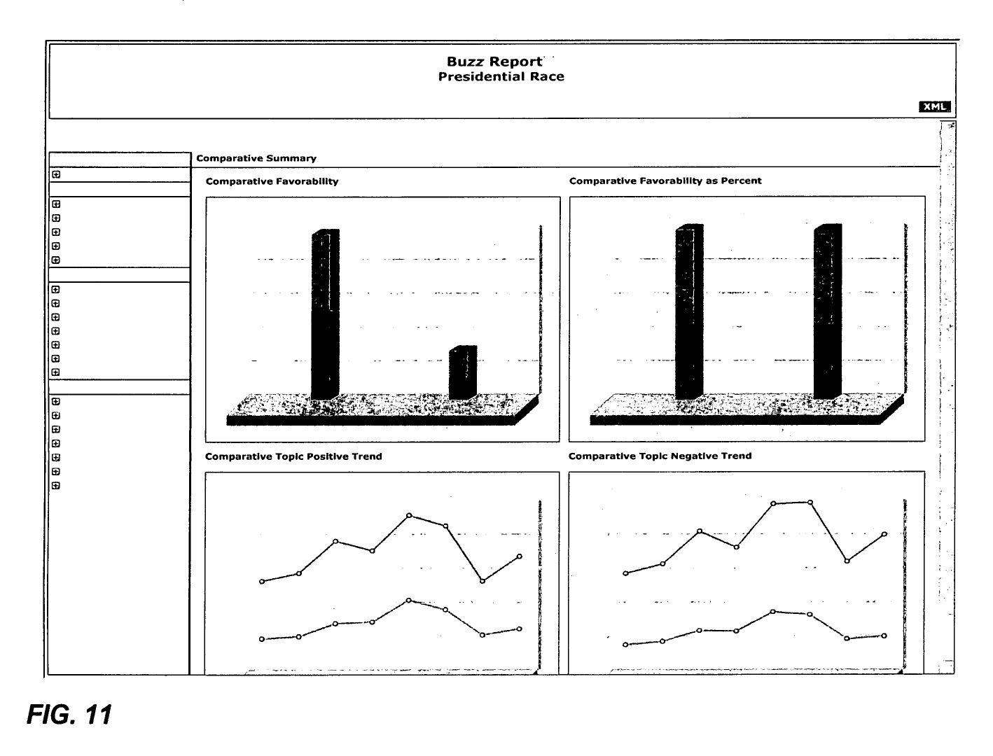

As shown in FIG. 2, the present invention involves collecting or capturing unstructured data from the various information sources. The service provides data collection processes such as web crawlers that actively seek out data (i.e., pull data) from the online community using the interfaces implemented by the various services that provide that data. Alternatively, data may be pushed from the various services to the centralized market intelligence service using data provider processes that execute in conjunction with the various online community services. The required web crawling technology is available from a variety of sources such as Semantic Discovery.

It is contemplated that the data collection mechanisms may vary depending on the type of online community service that is being examined. Web crawlers are suitable for sources such as weblogs, web sites, message boards and newsgroups, whereas other tools may be more appropriate to obtain data from email and chat sources. Real simple syndication (RSS) feeds may also be used to collect information by notifying a system of changes in particular information sources such as weblogs and web sites. Using notifications from an RSS feed allows the system to focus data collection processes on sources that have changed and specifically to collect new or modified information without. Of particular interest to the present invention is information that represents unsolicited information such as unsolicited opinions, commentary, analysis, observations, reviews, ratings and the like. This is often present in the form of a text message posted alone or as part of a conversation thread. By “unsolicited” it is meant that the information that is collected is not solicited by the system performing the collection. Information may, in fact, be in the form of a question-response thread between multiple third parties who are soliciting each others opinions. However, for purposes of the present invention such information is considered “unsolicited” because it retains the important characteristic that it is not affected by prompting from a person or organization that is studying the information.

It is desirable that the data be collected together with pointer or link information that provides a reference to the source of the information. In most cases this pointer takes the form of a uniform resource locator (URL) that can be used as a link back to the original source of the information. Other information such as date, length, screen name of the speaker, conversation thread identification, and the like may be captured along with the data itself.

Modeling and Analysis

Using natural language processing, the present invention enables users to mine and understand the online community and turn raw public opinion about companies, their products and their competition into marketing insight. The captured natural language text is analyzed to gain understanding of its meaning and generate a machine response. In most cases raw data is captured in the form of a text file that contains data representing one or more members of an online community (i.e., one or more speakers). The raw data is preferably maintained in the form of records such that each record is associated with a single speaker. Accordingly, it may be necessary to split files that represent multiple speakers into multiple records that each represents a single speaker.

In some implementations captured text is pre-processed to distill out the words that have significance to a particular task and remove symbols that are not useful. In some cases preprocessing may involve removing punctuation, capitalization, and common words such as conjunctions, prepositions, definite and indefinite articles and the like. Preprocessing may identify word stems and account for prefixes, suffixes, and endings (morphemes). Preprocessing results in a text file that is richer in meaningful content, but should be done in a manner that minimizes the risks associated with removing meaningful data. A number of algorithms and tools exist to assist linguistic specialists in developing preprocessing techniques that are suitable for a particular application, thereby improving the quality of subsequent analysis.

Developing a preprocessing tool for a particular application may require fine-tuning the preprocessing tool to a specified language, vocabulary vernacular or dialect native to the source of the textual information in order to efficiently filter out supplementary words and morphemes. For example, some weblogs may include frequent posts that include acronyms specific to a particular topic, or abbreviations (e.g., using “IMHO” to mean “in my humble opinion”). Such domain-specific acronyms and abbreviations may be useful “as is”, or may be handled by teaching the analysis tools to associate a meaning with the acronym, by expanding the abbreviations to their full word representation, translating the acronym/abbreviation into another word or phrase that represents the meaning, or other similar technique that preserves meaning while aiding subsequent analysis. It is contemplated that preprocessing may be implemented by conventional computer algorithms as well as adaptive or learning computer systems and neural network systems. Preprocessing may operate on whole words, phrases, word fragments, character n-grams, word-level n-grams or other character grouping used in natural language processing.

Captured data may also benefit from normalization before and/or after preprocessing. Particularly when working with data sources of varying length, longer entries or entries that repeat certain words frequently may appear to be more statistically significant to automated analysis software. Normalization is an automated process implemented according to algorithms or by neural network software/hardware to give weight to various words, phrases, or entire entries so as to account for known characterizes that will affect downstream semantic analysis.

In particular implementations of the present invention, linguistic analysis involves two distinct components. A first component involves processes that identify and/or imply speaker attributes. A second component involves processes that identify attributes of the speech and that derive meaning from the captured data. The attribute processes operate on individual records to identify speaker characteristics such as age, gender, national origin, political preference, geographic background, and other speaker attributes.

The record may contain information that explicitly states the attribute information such as in a signature line that states the speaker is male or female. More often, the speaker attribute information is implied from information in the message body. For example, a signature line that indicates “Sarah” would have a high probability of representing a female speaker. Speaker attribute implication may involve complex analysis of the vocabulary, sentence complexity, source of the message, message context, or other information.

Speaker attributes may refer not only to individual attributes such as gender, nationality, and the like, but also to roles or areas of expertise. Like other attributes, a speaker's role or area of expertise may be explicit in a message (e.g., a signature line that indicates “V.P. of Marketing”) or may be implied or derived by more sophisticated analysis (e.g., reference to domain specific acronyms such as PPC and PPCSE imply internet marketing expertise). Classification of speakers by roles and/or areas of expertise can be as useful as classification by personal attributes, especially when attempting to guage the veracity or accuracy of speaker.

In performing speaker attribute analysis it is useful to quantify “unique voices” represented in the captured data. A unique voice corresponds to a unique, particular speaker. In some cases it is useful to adjust the weight given to a collection of messages based on whether those messages represent a number of unique voices or a single, repetitive voice. A collection of messages may include multiple messages from a single speaker in which case all of the messages are associated with a single unique voice. In contrast, the collection of messages may include multiple messages where each speaker is unique and so each message is associated with a particular unique voice. In practice there is often a mix in which some unique voices are represented by one or a few messages and other voices are represented by many repetitive messages.

It is also useful to understand the contribution of “new voices” to a conversation. A topic may involve conversations that extend over a months or years. At various times there may be an increase in the number of new voices (i.e., new speakers) that are contributing to the conversation. For example, when analyzing marketing information about a particular product or service an increase in the number of new voices that are contributing opinions about that product or service indicates market activity that may suggest more attention or more detailed analysis of those conversations is in order. The speaker analysis features of the present invention enable identifying new voices and thereby quantifying increases and decreases in the number of new voices over time. Also, the sentiments expressed by new voices can be tracked separately from “older” voices to indicate changes in expressed opinions.

The present invention also performs a semantic analysis of each message to determine attributes of the speech itself. For example, an attribute might indicate a message thread to which the message belongs (e.g., a numerical thread ID or a text thread name). Also, attributes might indicate semantic characteristics that can be implied from the text. For example, an attribute of the speech might indicate whether the tone of the speech is positive or negative.

In a particular example the present invention uses statistical models to determine a confidence level for an implied attribute. A low confidence level will indicate that the attribute is less likely to be accurate. In this manner, in particular messages where the confidence level is below a preselected threshold (e.g., less than 50%), the attribute for that message will be indicated as indeterminate. The messages are saved along with the attribute information, confidence level for each attribute, and a pointer to the source of the message in a database for future use in reporting.

Analysis and Report Generation

FIG. 3 illustrates an exemplary clustering model that represents relationships between messages. In the conceptual illustration of FIG. 3, messages are represented by triangle-shaped icons. Messages have a semantic relationship with each other that indicates a degree of similarity between messages. For simplicity, FIG. 3 illustrates three dimensions by which similarity is measured, but any number of dimensions may be used depending on the nature of the inquiry, and the meaning of each dimension can be defined to satisfy the requirements of a particular application. A number of techniques are known that perform semantic analysis on data sets comprising text.

In an exemplary analysis, messages are analyzed to identify one or more topics that are associated with each message. This topic information can be associated with the message as an attribute, as described above. In accordance with the present invention, clusters 301 comprising messages of pre-selected similarity are identified within the topic. Optionally, sub-clusters 302 may be identified within the clusters by identifying messages with even greater similarity. Alternatively, sub-clusters can be identified using semantic dimensions different from those used to identify clusters. Hence, a cluster might be defined as a group of messages within a topic named “Presidential Election” that are similar in that they deal with environmental issues (e.g., have a high occurrence of words/phrases associated with environmental issues). The members of a cluster may be sub-clustered to identify positive-toned and negative-toned sub-clusters using semantic dimensions that reflect tone of speech.

Analysis and report generation are performed in response to a report request, which can be a “live” request made immediately by a user, or a stored request that runs periodically. A report request identifies one or more topics, features of interest within that topic, and attributes of interest within features as shown in FIG. 4. It is contemplated that “self-organized” reports on a particular topic might also be useful in which features and/or attributes are not specified. Instead, the clusters and/or sub-clusters can be used to provide features and attributes. Such reports allow one to identify what issues are being discussed by the online community without a priori knowledge of what those issues are.

When features are specified in a report request, the messages associated with the specified topic are analyzed to identify messages having sufficient semantic proximity to the request-specified feature. In the context of a product report, a topic might be a particular product such as an automobile. The request might specify features such as quality, price, reliability and the like. Messages within the topic that have words, phrases and/or attributes that indicate a similarity to the features are then selected and added to the appropriate feature set.

Similarly, attribute analysis involves identifying messages within each feature set that are semantically close to a request-specified attribute. Continuing the example above, appropriate attributes for the “quality” feature set might include manufacturing, interior, exterior, engine, and the like. In the case of the price feature set, attributes such as “too high” or “competitive” might be defined by a request. Messages within the feature sets that have words, phrases and/or attributes that indicate a similarity to the attributes are then selected and added to the appropriate attribute set.

It is contemplated that the techniques described herein can also be used to perform “influence analysis”. The present invention recognizes that some speakers tend to lead opinions of others. It can be particularly useful to identify and understand influential speakers independently of other speakers. Influence analysis refers to an attempt to identify and understand what voices are more (or less) influential in a particular conversation or group of conversations. Speakers may be influential in some contexts, but not in others, and so performing influence analysis on a conversation-by-conversation or topic-by-topic basis is expected to be most useful. Moreover, understanding sentiment of the speakers may provide more information as to whether a speaker is influential.

An area of analysis that is related to influence analysis is alternatively though of as “viewership analysis”, “readership analysis” or “audience analysis”. This type of analysis involves tracking the contributions to various conversations from the perspective of the speaker. A given speaker may access a variety of weblogs, for example, ranging in topics from political interests to entertainment and shopping interests. While conventional link analysis can determine which blogs link to a particular blog, only the viewer/reader typically knows the identity of the various sites that they visit, the frequency of those visits, and similar information about the participation in conversations at the blogs that were visited. The present invention contemplates viewership analysis performed by not just counting links to a source, but also following those links to collect and analyze data located at the site of the followed link. By way of a specific example, a weblog may contain a posting advocating passage of a particular referendum in a community. Because it is controversial, there may be hundreds or thousands of links to that weblog, however, the mere count of links does not provide intelligence as to whether the linkers are supportive of the position advocated. By following the links, collecting data, and performing analysis according to the present invention an intelligence report can be generated that provides information that is much more sophisticated than conventional link analysis.

The present invention also contemplates permission-based viewership analysis in which the viewer agrees to share information about their participation in conversations with a service that aggregates this information with information from multiple viewers to create a viewership model. This model transcends knowledge of a particular weblog, particular topic or particular conversation to enable more complex understanding of viewership and changes in viewship over time.

In particular implementations the present invention may provide data by way of a regularly scheduled report that conveys what the online community is saying about companies, their products and their competition. This information is provided in both a raw and consolidated, market segmented fashion to enable marketing professionals to better understand the perspectives and opinions of their customers and target markets. These reports can provide an unsolicited, honest and fresh insight into public opinion not available from traditional sources. An exemplary report shown in the figures is structured into multiple sections, including:

Detailed summary of the findings produced in the report.

Breakdown and segmentation by age, gender, or other attributes of the population expressing viewpoints and opinions regarding your client's products or topics of interest.

Breakdown and segmentation by age (and often gender) of the population expressing viewpoints and opinions regarding the products of your client's competition.

Summary of the raw opinion data with a determination as to the positive or negative opinion on the product or topic. Also included are the active URLs from which a user can further view the opinions of the “bloggers” with each blogger designated by the segment of the population they represent.

Cumulative graphs and tracking of opinion directions and perspectives.

Competitive comparisons enabling your clients to compare opinions and perspectives of their products or topics to those of their competitors.

Potential uses of the present invention include:

Companies wishing to better understand the opinions and perspectives on their products and services.

Companies wishing to gain a richer understanding of their position in the market relative to the competition.

Companies wishing to identify new trends, directions impacting their products and the directions their products take.

Public relations early warning systems to identify shifts in public opinion before those shifts can be detected in a marketplace.

Demographic research to collect and analyze intelligence about trends, changes and the like related to particular demographic groups.

Political candidates wishing to better understand the opinions and perspectives of the populace versus those of their opponents.

It is contemplated that modularized reporting formats are useful. A modularized format is akin to a report template that has a particular type of content to present data and analysis in forms that are useful to a particular industry or for a particular purpose. For example, a marketing report for a particular product will likely focus on a particular time span surrounding a product introduction and include an emphasis on “new voices”. In contrast, a political candidate may be interested in information representing longer periods of time and more interested in older voices and/or analyzing influencers. Modules can be prepared that define useful ways of presenting various types of information and then reports defined by specifying the data and analysis that are performed to generate the information for the reports.

In addition to reports, the present invention can be used to perform a more continuous type of analysis together with alerts and/or notifications when significant events are noted in the analyzed data. For example and ongoing analysis of selected political weblogs can be established with analysis tools defined to identify when a particular candidate or issue appears in the conversation. The analsysis can, for example, measure the frequency at which the candidate or issue appears, and gauge sentiment of the conversations. An alert can be generated when particular frequencies and/or measured positive/negative sentiment levels are reached. The alert may be a stand-alone product or may trigger the generation of a more detailed report to discover more.

In addition to research applications described above, particular applications for the present invention include:

Equity market analysis: Marketplace opinions and trends in those opinions can be a useful indicator of company success and failure. Significantly, unsolicited online data can provide prospective information about a company and predict trends whereas sales, income, and other financial data reflects historical information only. The present invention enables a deeper insight into opinions about a company and its products and services than is possible with conventional survey analysis or analysis of product sales information that reflect historical rather than prospective information about a company.

Corporate and Government Security: Businesses and government entities are increasingly concerned about physical and information security of their operations. Being able to gauge negative and positive sentiment as expressed in communications about the business or government entity can be used to predictively adjust security measures to identify and/or counteract security challenges. In such applications it is contemplated that internal information such as internal message boards, weblogs, and the like can be monitored to identify issues and trends.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method of generating intelligence from online data comprising:
capturing data from online information services;
determining speaker attributes associated with items of the captured data;
determining semantic attributes of the captured data; and
analyzing the captured data, speaker attributes, and semantic attributes to generate processed information based on the captured data

2. The method of claim 1 further comprising generating a report presenting the processed information.

3. The method of claim 1 wherein capturing comprises using a web crawler.

4. The method of claim 1 wherein the data comprises unsolicited opinion data.

5. The method of claim 1 wherein the act of determining speaker attributes comprises determining one or more attributes from the group consisting of: gender, age, income, ethnicity, sexual preference, education, and political preference.

6. The method of claim 1 wherein the act of determining speaker attributes comprises determining a role and/or area of expertise of the speaker.

7. The method of claim 1 wherein the act of analyzing comprises analyzing unique voices reflecting a frequency distribution of speakers within the captured data.

8. The method of claim 1 wherein the act of analyzing comprises analyzing new voices contributing opinions in the captured data.

9. The method of claim 1 wherein the act of determining semantic attributes comprises identifying a topic to which the message pertains.

10. The method of claim 1 wherein the act of determining semantic attributes comprises identifying whether the tone of the message is positive or negative with respect to a topic to which the message pertains.

11. The method of claim 1 wherein the act of analyzing comprises cluster analysis.

12. The method of claim 1 wherein the act of analyzing comprises identifying influential speakers.

13. The method of claim 1 wherein the act of analyzing comprises identifying influencable speakers.

14. An automated service for providing market research reports, wherein the service implements the method of claim 1.

15. The method of claim 1 wherein the information services comprises one or more services selected from the group consisting of: weblogs, web sites, chat rooms, message boards, Usenet groups, electronic mail, instant messaging (IM), podcasts, as well as video streams, audio streams and the like that have been transformed to a textual representation.

16. A method of collecting information from online sources comprising:
aggregating unsolicited data from a variety of sources;
associating each item of unsolicited data with a pointer to a particular one of the variety of information sources in which the item of unsolicited data appears;
identifying speaker attributes from the item of unsolicited data; and
associating the identified speaker attributes with the item of unsolicited data.

17. The method of claim 16 wherein the act of identifying speaker attributes comprises determining gender of the speaker.

18. The method of claim 16 wherein the act of identifying speaker attributes comprises determining one or more attributes selected from the group consisting of: age, gender, income, ethnicity, sexual preference, education and political preference.

19. The method of claim 16 wherein the act of identifying speaker attributes comprises determining a role and/or area of expertise of the speaker.

20. The method of claim 16 further comprising identifying semantic attributes identifying a topic to which the message pertains.

21. The method of claim 20 wherein the act of identifying semantic attributes comprises identifying whether the tone of the message is positive or negative with respect to a topic to which the message pertains.

22. A method of analyzing data from online data sources comprising:
identifying one or more topics within the data, wherein each topic is associated with a number of message items within the data;
associating each of the number of messages with speaker attribute information;
receiving a report request identifying one of the one or more topics; and
identifying a subset of the number of message items that satisfy a preselected criteria.

23. The method of claim 22 wherein the act of identifying a subset further comprises identifying message items having sufficient semantic proximity to a request-specified feature.

24. The method of claim 23 wherein the act of identifying a subset further comprises identifying messages within each subset that are semantically close to a request-specified attribute.

25. The method of claim 23 further comprising determining whether a message is associated with an influential speaker as compared to other messages.

26. The method of claim 23 further comprising determining whether a message is associated with a unique voice as compared to other messages.

27. The method of claim 23 further comprising determining whether a message is associated with a new voice as compared to other messages.

28. The method of claim 19 wherein the report request comprises a “live” request made immediately by a user,

29. The method of claim 22 wherein the report request comprises or a stored request that runs periodically.

30. The method of claim 22 wherein the report request identifies one or more topics, features of interest within that topic, and attributes of interest within features.
